(19) United States
(12) Patent Application Publication
(10) Pub. No.: US 2013/0234678 A1
(43) Pub. Date: Sep. 12, 2013

(54) ALTERNATOR RIPPLE VOLTAGE REDUCTION USING OUTPUT FEEDBACK TO AN INDEPENDENT FIELD COIL

(71) Applicants: Ciaran Patterson, Chicago, IL (US); Mahmood Pourkermani, Wilmette, IL (US)

(72) Inventors: Ciaran Patterson, Chicago, IL (US); Mahmood Pourkermani, Wilmette, IL (US)

(21) Appl. No.: 13/412,846

(22) Filed: Mar. 6, 2012

(51) Int. Cl. H02P 9/02

(52) U.S. Cl. 322/28

(57) ABSTRACT

A generator comprises first and second field coils whose combined magnetic flux causes stator current within one or more stator windings which, when rectified via a rectifier circuit, produces rectified output current with reduced voltage fluctuations. A filter circuit extracts the AC component of the rectified output current and delivers it to the second field coil. The magnetic flux generated by the second field coil modifies the magnetic flux of the first field coil effectively cancelling the voltage ripples associated with the rectified output current of the generator.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a generator and method of operation. In particular, the present invention relates to a generator which utilizes first and second field coils whose magnetic fluxes interact in such a way so as to reduce voltage fluctuations associated with the rectified output of the generator.

### BACKGROUND

The present invention seeks to address voltage fluctuations commonly associated with generator's rectified output. In particular, the present invention discloses a generator which includes two field coils whose magnetic fluxes interact resulting in lower voltage ripples that would otherwise be present in a generator with only one field coil. As known to artisans of ordinary skill, the field current in a field coil produces a magnetic flux which interacts with one or more stator windings to generate stator current. The stator current is subsequently rectified via a rectifier circuit. This rectified current waveform may be represented as a DC current plus an AC ripple current superimposed with the DC current. The present invention, advantageously utilizes the AC ripple current to feed a second field coil thereby generating a second magnetic flux. The second magnetic flux interacts with the first magnetic flux reducing voltage ripples associated with the rectified output current of the generator.

Voltage ripple in the rectified DC output voltage of an alternator occurs due to the AC voltage wave shape and rectification of multiple, partial overlapping of multiple AC voltage waves applied to a diode rectifier. For an alternator with two or more electrically independent stators (6 phase, 9 phase, etc.) the rectified DC voltage ripple can be reduced by introducing a slight angular offset between the AC voltage produced by individual stators so that, for example, the troughs in the rectified DC voltage of one stator correspond to the peaks in the rectified DC voltage of another and the total DC voltage produced by both, when their rectified DC voltages are connected in parallel, had lower net ripple than possible with either stator individually.

For smaller alternators with multiple separate stator windings, the stators are often connected directly in parallel prior to rectification so the AC voltage angular displacement and wave shape for two or more stators must be the same otherwise circulating currents occur with associated electrical losses and heat. Connecting multiple separate stator windings in parallel prior to rectification is often done to reduce the number of rectifier diodes, simplification of stator wiring, etc. For alternators with a single stator winding or multiple stator windings connected in parallel the ripple voltage of the rectified DC output can be high. Typical performance standards call for a maximum of 2V peak for a 28V DC alternator connected to vehicle type batteries and 7V peak when the same alternator is operated without batteries.

Alternator DC output voltage ripple can be reduced by connecting a capacitor to the rectified DC output of the alternator. For alternators with high ripple self-heating of the capacitor can occur and the maximum operating temperature of the capacitor can be exceeded, particularly when the capacitor is mounted on or inside the alternator and the alternator is located in an automotive under-the-hood environment where the ambient temperature may already be very high.

As an alternative to connecting a capacitor directly to the alternator another method is sought to modify the stator AC voltage waveform so that the rectified DC voltage of the alternator has lower ripple and the need to connect a capacitor directly to the alternator DC output voltage is avoided. The method of generating rectified output current via a generator according to the present invention provides the solution.

A typical alternator uses a field coil to create a magnetic flux through one or more stator windings. The power delivered to this field coil is typically much less than the generated output power of the alternator. A method is sought to modify the magnetic flux inside the alternator so that the voltage ripple of the rectified DC output is lowered. Reducing the ripple in this way has the advantage that circuit components need only filter with the field power (current or magnetic flux) and not the total output power of the alternator. As such, they are smaller in size and rating (temperature, current, etc.). The method of the present invention is intended to be applied to an alternator with homopolar magnetic flux. A homopolar magnetic flux occurs when the stator magnetic flux alternates between high magnetic flux and low magnetic flux without reversing direction between north and south orientation. Additionally the net magnetic flux through the core and shell of a homopolar alternator may be constant.

One method for modification of the alternator internal magnetic flux in response to voltage ripple is to connect the alternator output to a second coil inside the alternator with this second coil being capable of contributing to the alternator's total magnetic flux. A capacitor is necessary in series with this coil so only the undesirable, time-varying portion of the alternator output creates magnetic flux, i.e. ripple voltage or ripple current, and not the desirable, constant portion, i.e. average DC output voltage or current. This second or feedback field coil is initially separate from the main coil controlled by the voltage regulator.

By applying the alternator output ripple to a secondary coil in this way and by controlling the resulting orientation of the induced field, the voltage ripple of the alternator can be reduced substantially. A lower limit exists for the effectiveness of this method because as the alternator output ripple is reduced so too is the excitation applied to the second field coil. At very low frequency the impedance associated with the field coil inductance is low so the capacitor may also contribute directly to filtering the alternator output voltage in a conventional manner as described earlier but in this case the current through the capacitor is limited by the series resistance of the second field coil.

Remembering that the net magnetic flux in the core and shell of a homopolar alternator with a single field coil is constant, the second field acts to modulate the total magnetic flux in response to the alternator output voltage ripple. This modulation induces a magnetic flux and voltage opposing the voltage ripple thus reducing it.

Although various systems have been proposed which touch upon some aspects of the above problems, they do not provide solutions to the existing limitations in reducing voltage ripples of a generator's rectified output current. For example, in Latos et al., U.S. Pat. No. 6,181,112, an apparatus for limiting a peak voltage of a generator provides an auxiliary winding within the stationary exciter filed magnetic structure. The auxiliary winding is coupled to a controllable current source that provides a current to the auxiliary winding based upon an operating speed of the generator. The current flow is effective for moving the quiescent flux bias point of the exciter field magnetic structure for limiting the peak voltage for any operating speed of the generator. In essence, the apparatus in Latos reduces the peak voltage by limiting the magnetic flux in the exciter. The present invention reduces the peak-to-peak voltage ripple of the rectified DC voltage with no consideration of the peak value. Furthermore, the present invention does not require measuring the ripple voltage and responding to it. It simply applies a portion of the ripple voltage to a second coil that in turn reduces the ripple voltage. Additionally, Latos limits the flux in an effort to reduce peak voltage whereas no such flux restriction is necessary in the present invention.

Yoden, U.S. Pat. No. 4,871,960, discloses an output voltage control system for an electric generator having two field windings, wherein a rotary shaft of the generator is rotated by a power source such as an engine, for producing an output voltage. The control system includes a first control unit for supplying an electric current inversely proportionate to the output frequency of the generator to one of the field windings of the generator to produce a substantially constant output voltage for a stationary (fixed) load, and a second control unit for supplying an electric current derived from a portion of the output voltage produced at the generator output to the other of the field windings of the generator in the event of fluctuations in the generator load. The present system does not rely on the use of a stationary load and makes no attempt to control any voltage except the post-rectifier DC output voltage. Additionally the present invention uses a feedback ripple current which is proportional to the AC content of the rectified voltage, not inversely proportional to the frequency of the pre-rectified AC voltage. Additionally, the system described in Yoden is different in that it uses the secondary coil to regulator a second voltage derived from the generator system and it does this in response to changes in generator shaft RPM with an inverse-proportional relationship. The field current of the second field coil in the present invention is proportional to DC voltage ripple.

In today's modern vehicles, the vehicle electrical system comprises a large number of electrical components that consume large amounts of electrical power. Consequently, vehicle electrical systems use high power generators to meet the high electrical power requirement. Additionally, the vehicle electrical system incorporates electrical devices that are often sensitive to voltage fluctuations in the electrical system. As a result, the generator used in the vehicle electrical system must provide high electrical power while minimizing voltage fluctuations. This requires the generator to be capable of efficiently reducing such voltage fluctuations associated with its output current.

As a simple, yet efficient, alternative to existing technologies, the present invention offers a generator, utilizing two field coils, which is capable of providing high electrical power of high quality to multiple electrical components within the vehicle electrical system. In particular, the generator and method of generating rectified output current according to the present invention utilizes first and second field coils whose combined magnetic flux produces an output current with reduced voltage fluctuations. A filter circuit filters the rectified output current and the resulting AC current is fed into the second field coil whose magnetic flux modifies that of the first field coil's thereby reducing the voltage fluctuations associated with the rectified output current.

### SUMMARY

The present invention discloses a generator, including method of operation, wherein the generator comprises first and second field coils whose magnetic fluxes interact in such a way so as to reduce voltage ripples associated with the rectified output of the generator. The rectified output current of the generator, resulting from the magnetic flux of the first field coil, is filtered and fed back into the second field coil. The corresponding magnetic flux of the second field coil interacts with the magnetic flux of the first field coil thereby reducing voltage ripples associated with the generator's rectified output current.

In one aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the rectifier circuit comprises a plurality of diodes.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the filter circuit comprises a capacitor. Preferably, the capacitor is coupled electrically in series with the second field coil.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the first field coil is coupled electrically in parallel with the second field coil.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the generator is a homopolar alternator.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the second field current is substantially 180 degrees out of phase with the first field current.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the first and second field coils are wound, axially adjacent, around a bobbin.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the first and second field coils are wound, radially adjacent, around a bobbin.

In another aspect, a generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current. Preferably, the generator further comprises a voltage regulator configured to regulate an output voltage of the generator at a regulation voltage. Preferably, the voltage regulator comprises a switch module operative to switch on/off the first field coil in response to the output voltage. Preferably, the switch module comprises a transistor. Preferably, the voltage regulator comprises a microcontroller configured to measure the output voltage and apply a control signal to the switch module in response to the output voltage.

In another aspect, a vehicle electrical system comprises a generator, said generator comprises a first field coil which generates a first magnetic flux due to first field current through the first field coil. One or more stator windings interact with the first magnetic flux and generate stator current which is rectified via a rectifier circuit to produce generator rectified output current. A filter circuit, responsive to the rectified output current, generates second field current which is fed back into the second field coil. The second field coil, responsive to the second field current, generates a second magnetic flux which modifies the first magnetic flux to reduce voltage ripples associated with the rectified output current.

In another aspect, a method for generating rectified output current via a generator comprises generating a first magnetic flux via a first field coil which is responsive to first field current, generating stator current via one or more stator windings interacting with the first magnetic flux, generating second field current via a filter circuit responsive to the rectified output current, generating a second magnetic flux via a second field coil which is responsive to the second field current, and modifying the first magnetic flux by the second magnetic flux to reduce voltage ripples associated with the rectified output current.

In another aspect, a method for generating rectified output current via a generator comprises generating a first magnetic flux via a first field coil which is responsive to first field current, generating stator current via one or more stator windings interacting with the first magnetic flux, generating second field current via a filter circuit responsive to the rectified output current, generating a second magnetic flux via a second field coil which is responsive to the second field current, and modifying the first magnetic flux by the second magnetic flux to reduce voltage ripples associated with the rectified output current. Preferably, the method comprises generating the second field current substantially 180 degrees out of phase with the first field current. Preferably, the method further comprises regulating an output voltage of the generator via a voltage regulator.

In another aspect, a method for reducing voltage ripples associated with a generator's rectified output current comprises generating a first magnetic flux via a first field coil which is responsive to first field current, generating a second magnetic flux via a second field coil which is responsive to second field current having a phase shift with the first field current, and modifying the first magnetic flux by the second magnetic flux.

In another aspect, a method for reducing voltage ripples associated with a generator's rectified output current comprises generating a first magnetic flux via a first field coil which is responsive to first field current, generating a second magnetic flux via a second field coil which is responsive to second field current having a phase shift with the first field current, and modifying the first magnetic flux by the second magnetic flux. Preferably, the phase shift is substantially equal to 180 degrees.

In another aspect, a method for controlling a vehicle electrical system comprises generating a first magnetic flux via a first field coil which is responsive to first field current, generating a second magnetic flux via a second field coil which is responsive to second field current having a phase shift with the first field current, and modifying the first magnetic flux by the second magnetic flux. Preferably, the phase shift is substantially equal to 180 degrees.

### BRIEF DESCRIPTION OF THE DRAWINGS

FIG. 1 shows a block diagram of a vehicle electrical system comprising a generator, a voltage regulator, and electrical load, wherein the regulator comprises two field coils and a filter circuit according to a preferred embodiment.

FIG. 2 shows a schematic diagram of the electrical connections between the various components within the generator of FIG. 1 according to a preferred embodiment.

FIG. 3 is a flow diagram of one preferred method of operation of the generator FIGS. 1 and 2.

### DETAILED DESCRIPTION OF THE PRESENTLY PREFERRED EMBODIMENTS

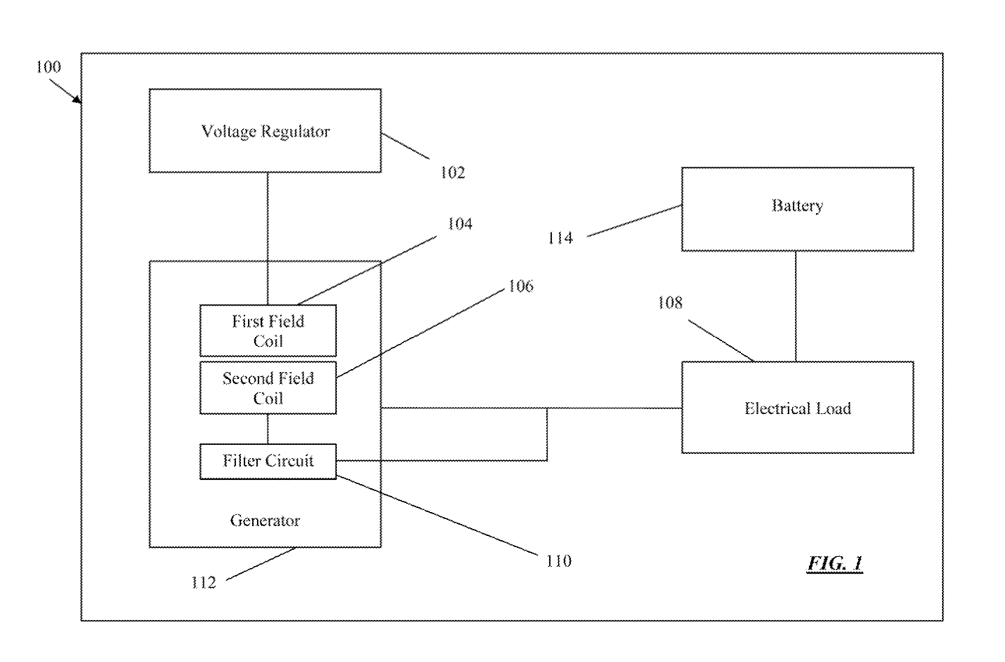

FIG. 1 depicts a block diagram of a preferred embodiment of a vehicle electrical system 100, including a generator 112, voltage regulator 102, electrical load 108, and battery 114. The generator 112 is connected to and in communication with the voltage regulator 102 and operates to deliver electrical power to the electrical load 108. The voltage regulator 102 operates to maintain the generator output voltage at a constant voltage as the speed of the generator 112 and electrical load 108 vary. The electrical load 106 represents electrical loads by electrical components which may comprise a heating element, an air conditioning unit, a compressor, a cooling fan, headlights, a battery, or a pump, to name a few examples. The generator 112 comprises a first field coil 104, second field coil 106, and filter circuit 110.

The first field coil 104 is operated by the voltage regulator 102 to produce a first magnetic flux in response to first field current through the first field coil 104. In a preferred embodiment, the first field current is generated when the voltage regulator 102 switches on/off the first field coil 104 in accordance with the speed of the generator 102 and electrical power demand by the electrical load 108. The first magnetic flux, thus generated, interacts with one or more stators (not shown) of the generator 112, producing stator currents in the stator windings. A rectifier circuit (not shown) operates to rectify the stator currents and generate rectified output current which feeds the electrical load 108. As known to artisans of ordinary skill, such rectified output current carry voltage variations, commonly known as voltage ripples.

The second field coil 106 is driven by the output current of the generator 112. In a preferred embodiment, the second field coil 106 is coupled with the output of the generator 112 via the filter circuit 110, inducing second field current through the second field coil 106. The filter circuit 110 operates to pass only the current ripples associated with the output current of the generator 112 through the second field coil 106. The second field coil 106 produces a second magnetic flux in response to the second field current. As described more fully below, the second magnetic flux modifies the first magnetic flux which results in reduced voltage variations associated with the rectified output current of the generator 112.

In one embodiment, the generator 112 is a homopolar brushless alternator having a first field coil 104 that generates a first magnetic flux when first field current passes through the first field coil 104. The first magnetic flux interacts with one or more stator windings in the generator 112, inducing voltage across the stators which, in turn, produce the generator output current for consumption by the electrical load 108. The voltage regulator 102 is coupled with the generator first field coil 104 and operates to regulate the system voltage at a regulation voltage, for instance 28 V, by switching on/off the first field coil, thereby, varying the average value of the first field current.

The voltage regulator 102 comprises one or more switches (not shown) to accomplish this. In one instance, the voltage regulator 102 may utilize two switches. A first switch is disposed between one end of the first field coil 104 and a voltage source, such as a battery 114, and a second switch is disposed between the other end of the first field coil 104 and the battery 114. The voltage regulator 102 senses the output voltage of the generator 112 and applies a control signal to switch on/off the first switch to maintain the system voltage at the regulation voltage, and applies another control signal to switch off the second switch in response to a generator output voltage that is above a threshold value for a predetermined time interval. Following this over voltage condition and upon a system reset, the regulator switches on the second switch to continue normal operation. In this two-switch configuration, the voltage regulator 102 uses the first switch to regulate the system voltage at the regulation voltage, and the second switch to further prevent over voltage conditions that may occur when an electrical load 108 is suddenly disconnected.

In light of such voltage regulation and over voltage protection, voltage variation/ripple of the generator output exists and remains as an undesirable component of the generator output. In applications where the electrical system does not allow for the battery 114, the amplitude of such voltage variation is even higher. The generator output voltage variation can cause malfunction or damage certain electrical components within the electrical system. The dual field coil generator of the present invention advantageously uses the very voltage ripple of the generator output current to eliminate or substantially reduce its amplitude.

In either one-switch or two-switch configurations, the first field current through the first field coil 104 produces a first magnetic flux which induces voltage across the generator stators thereby generating the stator currents through the generator stators. As is known to artisans of ordinary skill, upon rectification of the stator currents, the corresponding generator output current comprises current ripples. This may be readily observed by monitoring the voltage across the output terminal of the generator 112 and ground using an oscilloscope.

The actual generator output current waveform maybe modeled as the superposition of a constant DC current and a time-varying AC current. The time-varying AC current waveform is the result of several factors including the number of stator phases in each generator stator, generator speed, electrical power demand by the electrical load 108, etc. The time-varying AC current waveform is in general complex in form, comprising many harmonics of varying amplitudes. The very time-varying AC current waveform may be used advantageously to substantially reduce its amplitude. In a preferred embodiment, the filter circuit 110 is connected to the output terminal of the generator 112 which filters the DC current and passes the AC current through the second field coil 106. The corresponding second field current through the second field coil 106 generates the second magnetic flux which, in turn, modifies the first magnetic flux, resulting in reduction in the amplitude of the current ripples.

As known to artisans of ordinary skill, the resulting stator currents in the stator windings of the generator 112, due to the modified first magnetic flux, maybe described as the superposition of first stator currents in the stator windings of the generator 112 due to the first magnetic flux and second stator currents in the stator windings of the generator 112 due to the second magnetic flux. The first magnetic flux generates an output current which includes the constant DC current and time-varying AC current. The second magnetic flux generates an output current which includes only the time-varying AC current. Subtracting the time-varying AC current, produced by the second magnetic flux, from the total output current of the generator 112, produced by the first magnetic flux results in elimination or substantial reduction in the amplitude of the time-varying AC current. A change in polarity across the second field coil 106, or alternatively, introduction of a 180 degrees phase shift between the first field current and second field current, i.e., reversal of direction of the second field current with respect to the direction of the first field current, effectuates the above-mentioned subtraction of the time-varying AC current from the total output current of the generator 112 resulting in reduced voltage ripples associated with the rectified output current of the generator 112.

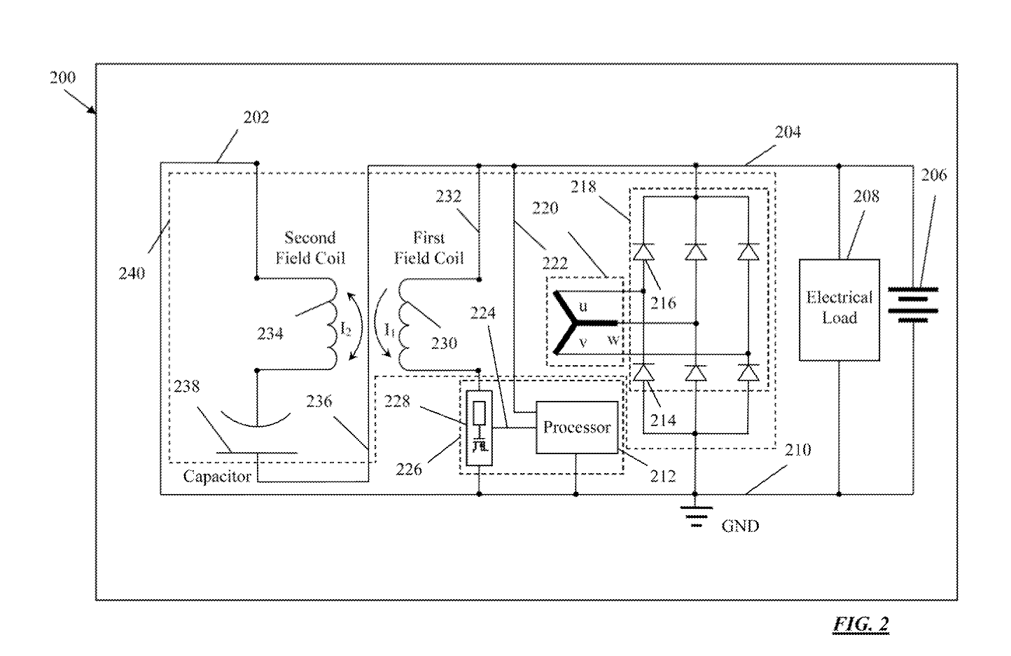

FIG. 2 shows a schematic diagram 200 of the electrical connections between the various components within the vehicle electrical system of FIG. 1 according to a preferred embodiment. In this configuration, a generator 240, such as the generator 112, comprises a first field coil 230, a second field coil 234, a three-phase stator 220, and a full-wave rectifier circuit 218. The generator 240 produces electrical current at its output 204, through an electrical load 208, to ground at 210. The battery 206 provides electrical power to the electrical load 208 when the generator 240 is not operating. The electrical load 208 represents one or more electrical loads by electrical components such as those mentioned above. In this preferred embodiment, the voltage regulator 226, such as that depicted in FIG. 1 as component 102, is represented by a processor 212 and single regulating switch 228. As such the voltage regulator 226 switches on/off the switch 228 to regulate the output voltage of the generator 240. The generator 240 further includes a capacitor 238 coupled in series between the output of the generator 240 and ground 210 as the filter circuit such as the filter circuit 110 of FIG. 1.

According to this preferred embodiment, the generator 240 comprises the first field coil 230 whose first field current generates first magnetic flux which, in turn, induces an alternating voltage across three phase windings, u, v, and w of the three-phase stator 220. The full-wave rectifier circuit 218 comprises a negative diode 214 and positive diode 216 for each of the three phase windings, providing rectified output current to the electrical load 208 which represents one or more electrical loads by electrical components such as those mentioned above. The rectified output current waveform on line 204 is a time-varying current. As mentioned above, this output current may be modeled as the superposition of a constant DC current and a time-varying AC current.

The voltage regulator 226 comprises the processor 212 and switch 228 which operates to regulate the output voltage of the generator 240. The processor 212 measures the output voltage of the generator 240 via an output voltage line 222 and varies a duty cycle of the first field coil 230 by applying a control signal to the switch 228 via a control line 224. The processor 212 may be analog or digital such as a microprocessor. In one preferred embodiment, the microprocessor is a 68HC08 processor having internal flash memory available from Freescale of Scottsdale, Ariz. It is contemplated that the processor may be a combination of individual discrete or separate integrated circuits packaged in a single housing or it may be fabricated in a single integrated circuit. The switch 228 may be a semiconductor switch.

The corresponding first field current through the first field coil 230 is unidirectional and generates a first magnetic flux operative to induce alternating voltage across the three phase windings u, v, and w which, in turn, produces alternating stator current through the three phase windings u, v, and w. Each phase is connected to a corresponding positive diode 216 and negative diode 214 which generates rectified current. The sum of all three rectified currents, produced by each phase, feeds the electrical load 208 and battery 206. As mentioned above, this rectified output current maybe decomposed into a constant DC current and a time-varying AC current which is commonly known as current ripple.

The capacitor 238 is electrically connected in series to the generator output 204 and operates to filter the rectified output current and generate the second field current. The capacitor 238 effectively separates the constant DC current from the time-varying AC current and allows only the latter to flow bidirectionally through the second field coil 234 and generate the second magnetic flux. The second magnetic flux modifies the first magnetic flux which results in reduced voltage ripples associated with the rectified output current.

The first field coil 230 is electrically connected in parallel to the second field coil 234. The direction of the second field current is opposite to the direction of the first field current, hence, the second field current is substantially 180 degrees out of phase with the first field current. Each of the first and second field coils may be wound in separate bobbins or a common bobbin and disposed axially adjacent to one another. Alternatively, each of the first and second field coils may be wound in separate bobbins or a common bobbin and disposed radially adjacent to one another. It is the directions of the first and second field currents and spatial orientation of the corresponding first and second magnetic fluxes that determines the rectified output current waveform.

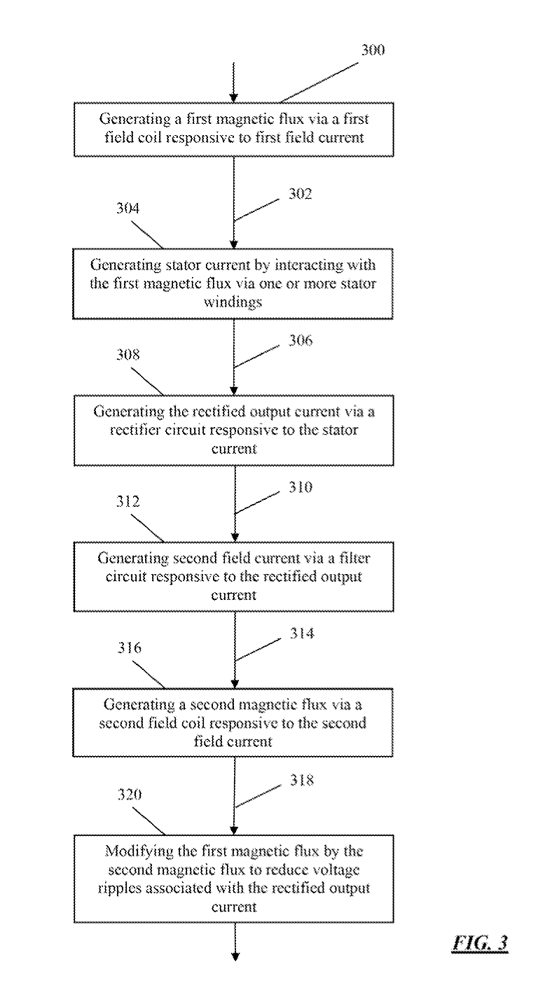

FIG. 3 is a flow diagram of one preferred method of generating rectified output current via a generator such as the generator 112 or 240 of FIGS. 1 and 2, the latter being used as reference to describe the method. According to this embodiment, the method comprises generating a first magnetic flux via a first field coil 230 at 300. The first magnetic flux is in response to the first field current through the first field coil 230. The method further includes generating stator current by interacting with the first magnetic flux via one or more stator windings at 304. Stator current is generated in stator windings, such as the phase windings, u, v, and w. The method further includes generating rectified output current via a rectifier circuit at 308. The rectified circuit, comprising of three positive diodes 216 and three negative diodes 214, responses to the stator current and generates the rectified output current of the generator 240. The method further includes generating second field current via a filter circuit at 312. The filter circuit comprises the capacitor 238 which is filters the rectified output current to pass only the time-varying AC current through the second field coil 234. The method further includes generating second magnetic flux via a second field coil at 316. The second field coil 234 generates the second magnetic flux in response to the second field current comprising the time-varying AC current. The method further includes modifying the first magnetic flux by the second magnetic flux at 320. The modified first magnetic flux produces rectified generator output current having substantially reduced voltage ripples.

The foregoing discloses a generator having two field coils producing two magnetic fluxes. The combined magnetic flux induces voltage across stator windings whose corresponding stator current, when rectified via a rectifier circuit, produces rectified output current with reduced voltage fluctuations. A filter circuit is connected to the generator rectified output and allows only time-varying AC current to flow through the second field coil. The magnetic flux generated by the second field coil modifies the magnetic flux of the first field coil effectively eliminating or substantially reducing the voltage ripples associated with the rectified output current of the generator.

The foregoing explanations, descriptions, illustrations, examples, and discussions have been set forth, to assist the reader with understanding this invention and further to demonstrate the utility and novelty of it and are by no means restrictive of the scope of the invention. It is the following claims, including all equivalents, which are intended to define the scope of this invention.

What is claimed is:

1. A generator comprising:
(a) a first field coil responsive to first field current and operative to generate a first magnetic flux;
(b) one or more stator windings interacting with the first magnetic flux and operative to generate stator current;
(c) a rectifier circuit responsive to the stator current and operative to generate rectified output current;
(d) a filter circuit responsive to the rectified output current and operative to generate second field current; and
(e) a second field coil responsive to the second field current and operative to generate a second magnetic flux;
wherein the second magnetic flux modifies the first magnetic flux to reduce voltage ripples associated with the rectified output current.

2. The generator of claim 1, wherein the rectifier circuit comprises a plurality of diodes.

3. The generator of claim 1, wherein the filter circuit comprises a capacitor.

4. The generator of claim 3, wherein the capacitor is coupled electrically in series with the second field coil.

5. The generator of claim 1, wherein the first field coil is coupled electrically in parallel with the second field coil.

6. The generator of claim 1, wherein the generator is a homopolar alternator.

7. The generator of claim 1, wherein the second field current is substantially 180 degrees out of phase with the first field current.

8. The generator of claim 1, wherein the first and second field coils are wound, axially adjacent, around a bobbin.

9. The generator of claim 1, wherein the first and second field coils are wound, radially adjacent, around a bobbin.

10. The generator of claim 1, further comprising a voltage regulator configured to regulate an output voltage of the generator at a regulation voltage.

11. The generator of claim 10, wherein the voltage regulator comprises a switch module operative to switch on/off the first field coil in response to the output voltage.

12. The generator of claim 11, wherein the switch module comprises a transistor.

13. The generator of claim 11, wherein the voltage regulator comprises a microcontroller configured to measure the output voltage and apply a control signal to the switch module in response to the output voltage.

14. A vehicle electrical system comprising the generator of claim 1.

15. A method for generating rectified output current via a generator, said method comprising:
(a) generating a first magnetic flux via a first field coil responsive to first field current;
(b) generating stator current by interacting with the first magnetic flux via one or more stator windings;
(c) generating the rectified output current via a rectifier circuit responsive to the stator current;
(d) generating second field current via a filter circuit responsive to the rectified output current;
(e) generating a second magnetic flux via a second field coil responsive to the second field current; and
(f) modifying the first magnetic flux by the second magnetic flux to reduce voltage ripples associated with the rectified output current.

16. The method of claim 15, wherein (d) comprises generating the second field current substantially 180 degrees out of phase with the first field current.

17. The method of claim 15, further comprising:
(g) regulating an output voltage of the generator via a voltage regulator.

18. A method for reducing voltage ripples associated with a generator's rectified output current comprising:
(a) generating a first magnetic flux via a first field coil responsive to first field current;
(b) generating a second magnetic flux via a second field coil responsive to second field current having a phase shift with the first field current; and
(c) modifying the first magnetic flux by the second magnetic flux.

19. The method of claim 18, wherein the phase shift is substantially equal to 180 degrees.

20. A method of controlling a vehicle electrical system comprising the method of claim 18.
